(19) United States
(12) Patent Application Publication
(10) Pub. No.: US 2007/0223477 A1
(43) Pub. Date: Sep. 27, 2007

(54) Packet recognizer with hardware/software tradeoff

(76) Inventor: John C. Eidson, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/390,741

(22) Filed: Mar. 27, 2006

(51) Int. Cl. H04L 12/56

(52) U.S. Cl. 370/392

(57) ABSTRACT

Techniques that enable a design tradeoff between performing packet recognition in hardware and software. A packet recognizer according to the present teachings includes a hardware portion having a functionality that is selected in response to a tradeoff in a relative complexity of the hardware portion and a software portion of the packet recognizer.

### BACKGROUND

A wide variety of devices may communicate with one another using a packet-based communication network. Examples of devices that may communicate on a packet-based communication network include computer systems, test and measurement instruments, industrial control devices, home appliances, etc. One example of a packet-based communication network is an Ethernet network with Internet protocols.

A device that communicates on a packet-based communication network may measure the transmit or receive times of packets. For example, a device that communicates on a packet-based communication network may participate in a time synchronization protocol that includes measuring a transmit and receive times of timing packets carried on the communication network. One example of a time synchronization protocol that includes measuring transmit and receive times of timing packets is the IEEE 1588 time synchronization protocol.

A device may include a protocol stack that enables code executing on the device to communicate using a packet-based communication protocol. A protocol stack may include a set of software layers that provide an interface between code executing on the device and the hardware communication components in a device.

A protocol stack may introduce a substantial amount of jitter into measurements of the transmit and receive times of packets. A substantial amount of jitter in the measurements of the transmit and receive times of packets may, for example, reduce the precision of time synchronization.

A device may include a hardware packet recognizer that measures the receive times of incoming packets before the incoming packets reach the protocol stack, thereby avoiding jitter in receive time measurements caused by the protocol stack. Similarly, a hardware packet recognizer may be used to measure transmit times of outbound packets.

Some packet-based communication protocols may include a packet format that is amenable to relatively simple data comparisons on fixed locations within a packet header. Other packet-based communication protocols may include a packet format that is not amenable to relatively simple data comparisons on fixed locations within a packet header. For example, Ethernet protocol IPV6 may require a relatively complex parsing of a packet header to detect a timing packet. Similarly, encrypted packets may require relatively complex analysis to detect a timing packet. Unfortunately, a relatively complex parsing of a packet may substantially increase the cost of a hardware packet recognizer. In addition, parsing of packets in hardware may not be easily modified to accommodate changes in communication protocols.

### SUMMARY OF THE INVENTION

Techniques are disclosed that enable a design tradeoff between performing packet recognition in hardware and software. A packet recognizer according to the present teachings includes a hardware portion having a functionality that is selected in response to a tradeoff in a relative complexity of the hardware portion and a software portion of the packet recognizer.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a device that incorporates the present teachings;

FIG. 2 shows a method for designing a packet recognizer according to the present teachings.

### DETAILED DESCRIPTION

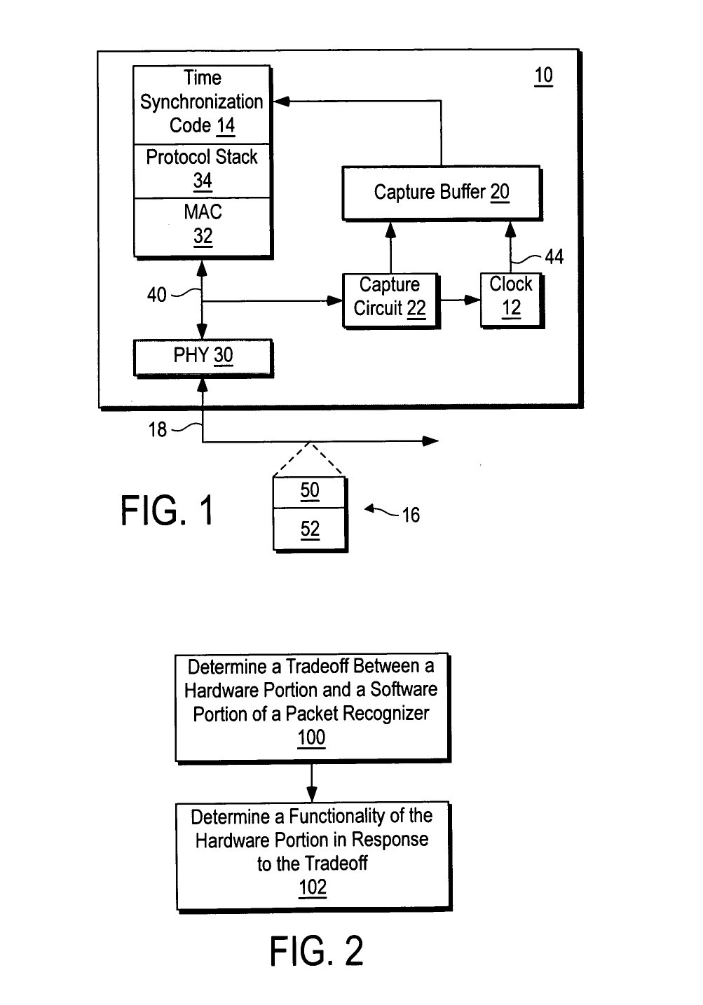

FIG. 1 shows a device 10 that incorporates the present teachings. The device 10 includes a clock 12 and time synchronization code 14 that determines time updates for maintaining time-of-day synchronization in the clock 12 in response to timing packets carried on a network communication link 18. In one embodiment, the time synchronization code 14 synchronizes the clock 12 according to the IEEE 1588 time synchronization protocol.

The device 10 includes a set of hardware and software components that enable code executing on the device 10, e.g. the time synchronization code 14, to communicate via the network communication link 18 using a packet-based communication protocol. In the embodiment shown, the hardware and software components in the device 10 for packet-based communication via the network communication link 18 include a physical interface (PHY) 30, a media access controller (MAC) 32, and a protocol stack 34.

On the outbound side, the protocol stack 34 receives outbound data from applications executing on the device 10, e.g. the time synchronization code 14, and constructs outbound packets that include the outbound data as payload. The protocol stack 34 provides the outbound packets to the MAC 32 and the MAC 32 uses the PHY 30 to transmit the outbound packets via the network communication link 18. On the inbound side, the PHY 30 receives inbound packets via the network communication link 18 and provides the inbound packets to the MAC 32. The MAC 32 provides the inbound packets to the protocol stack 34 and the protocol stack 34 processes the header information of the inbound packets and provides the payloads from the inbound packets to the appropriate application executing on the device 10, e.g. the time synchronization code 14.

A timing packet carried on the network communication link 18 may be distinguished as a timing packet from other types of packets by a timing packet indicator contained in one or more predetermined fields of a header of the packet. One example of a timing packet is a sync packet according to the IEEE 1588 time synchronization protocol. Another example of a timing packet is a delay request packet according to the IEEE 1588 time synchronization protocol. An IEEE 1588 timing packet indicator may be a predetermined multicast address in its header.

The location of a timing packet indicator in a header of a packet carried on the network communication link 18 may depend on the values contained in other fields of the header. For example, a packet carried on the network communication link 18 that conforms to the Ethernet protocol IPV6 may require parsing to locate its timing packet indicator. In another example, a packet carried on the network communication link 18 may be encrypted such that its timing packet indicator is not in a fixed location.

The device 10 includes a capture circuit 22 and a capture buffer 20 that enable the task of parsing packets to be performed in software while still retaining the benefits of hardware packet detection. For example, the capture circuit 22 yields the benefits of improved time synchronization accuracy by time stamping timing packets in hardware while the capture circuit 22 and the capture buffer 20 together with the time synchronization code 14 reduce the cost and complexity of packet recognition in hardware by enabling the headers of timing packets to be parsed in software.

An example inbound packet 16 is shown on the network communication link 18. The inbound packet 16 includes a header 50 and a payload 52. The PHY 30 receives the inbound packet 16 via the network communication link 18 and provides it to the MAC 32. The capture circuit 22 captures a portion of the inbound packet 16 by snooping a media independent interface (MII) 40 between the PHY 30 and the MAC 32. The capture circuit 22 stores the captured portion of the inbound packet into the capture buffer 20. In addition, the capture circuit 22 causes the clock 12 to generate a timestamp 44 when the inbound packet 16 is detected on the MII 40. The timestamp 44 is stored into the capture buffer 20.

Thereafter, the protocol stack 34 obtains the inbound packet 16 from the MAC 32 and processes the header 50. The protocol stack 34 provides the payload 52 of the inbound packet 16 to the appropriate application executing on the device 10. If the inbound packet 16 is a timing packet then the protocol stack 34 provides the payload 52 to the time synchronization code 14.

The time synchronization code 14 reads the captured portion of the inbound packet 16 from the capture buffer 20 and parses the captured portion to determine whether or not the inbound packet 16 is a timing packet to be used in synchronizing the clock 12. For example, the time synchronization code 14 may parse an IPV6 header in the capture buffer 20 and perform a comparison on the timing packet indicator in the header. In another example, the time synchronization code 14 may decrypt an encrypted header contained in the capture buffer 20 to detect whether or not it includes a timing packet indicator.

The time synchronization code 14 also reads the captured timestamp from the capture buffer 20 and uses it in its time synchronization calculations if the inbound packet 16 is a valid timing packet with respect to the device 10. The time synchronization code 14 also obtains the payload 52 of the inbound packet 16 via the protocol stack 34 and may use information from the payload 52 in time synchronization calculations.

The portion of the inbound packet 16 captured by the capture circuit 22 may be the header 50 of the inbound packet 16. The header 50 of the inbound packet 16 may have a predetermined length. For example, the capture circuit 22 may detect a start-of-frame (SOF) of the inbound packet 16 and then capture subsequent octets from the inbound packet 16 until the predetermined length is of the header 50 is reached.

The header 50 of the inbound packet 16 may have a variable length that is specified in a field of the header 50 at a known location in the header 50. For example, the capture circuit 22 may detect a start-of-frame of the inbound packet 16 and then read the length of the header 50 from the known location after the start-of-frame and then capture octets from the inbound packet 16 until the specified length of the header 50 is reached.

Alternatively, the capture circuit 22 may detect a start-of-frame of the inbound packet 16 and then capture octets from the inbound packet 16 until a sufficient number of octets are captured to ensure that the time synchronization code 14 will have enough captured information available in the capture buffer 20 to analyze the inbound packet 16. The number of octets captured may be based on the maximum possible length of the header 50 of the inbound packet 16.

The capture circuit 22 may filter out, i.e. not capture, inappropriate packets when snooping the MII 40. For example, the capture circuit 22 may include an address filter that filters out the inbound packet 16 if its destination address does not match that of a predetermined destination address associated with clock synchronization or associated with the device 12. The destination address may be at a fixed location in the header 50 and the capture circuit 22 may determine whether or not to accept an incoming packet by performing a comparison on the data in the fixed location.

The capture circuit 22 and the capture buffer 20 also enable the task of parsing outbound timing packets to be performed in software while still retaining the benefits of hardware packet detection. For example, capture circuit 22 captures a portion of an outbound packet by snooping the MII 40. The capture circuit 22 stores the captured portion of the outbound packet, e.g. its header, into the capture buffer 20. In addition, the capture circuit 22 causes the clock 12 to generate a timestamp when the outbound packet is detected on the MII 40 and that timestamp is stored into the capture buffer 20. The time synchronization code 14 reads the captured portion of the outbound packet from the capture buffer 20 and parses the captured portion. An outbound packet may be encrypted in the MAC 32 or the protocol stack 34 and so decryption on its captured header may be performed by the time synchronization code 14. For example, IEEE 1588 sync and delay request packets may be time-stamped both on sending and receipt using the capture circuit 22 and the capture buffer 20.

The capture circuit 22 is adapted to recognize a field in a packet that identifies the packet as potentially interesting to the time synchronization code 14. In the case of Ethernet and IEEE 1588 time synchronization, for example, the identifying field is a multicast address. The identifying field in a packet may be an “in the clear” field that is readily found, e.g. a field that is in the clear for other network devices such routers. The information captured in the capture buffer 20, in the case of timing packets, may be used by the time synchronization code 14 to determine whether a corresponding packet is a sync or a delay request and to locate sequence numbers, UUID, etc. in sync and delay request packets. The fields that carry sequence numbers, UUID, etc., may be encrypted or may be difficult to locate without parsing a packet header.

The time synchronization code 14 decrypts a packet if needed in accordance with any encryption/decryption implemented in the protocol stack 34. For example, if the inbound packet 16 is encrypted then the time synchronization code 14 performs the same decryption that is performed by the protocol stack 34 when processing the header 50 and the payload 52.

The time synchronization code 14 parses a packet header captured in the capture buffer 20 in accordance with the parsing performed by the MAC 32, e.g. using known techniques. For example, the time synchronization code 14 parses the captured header 50 of the inbound packet 16 using code analogous to the implementation of the MAC 32. The software parsing implemented in the time synchronization code 14 may include state machines, pattern matching scans, etc. The computational burden of the parsing may be minimal given that timing packets are relatively infrequent.

The present techniques enable a design trade-off between employing complex hardware and simple software for packet recognition versus simple hardware and more complex software. An advantage of implementing the complexities of packet recognition in software is that software is generally easier to update in comparison to hardware if protocols change.

FIG. 2 shows a method for designing a packet recognizer in a device according to the present teachings. At step 100, a tradeoff in a relative complexity of a hardware portion of the packet recognizer and a software portion of the packet recognizer is determined. The determination at step 100 may be performed in response to the needs of a particular communication protocol. For example, some protocols may require relatively complex parsing or decryption of packets. The determination at step 100 may be performed in response a set of costs associated with the hardware and software portions. For example, a device may have constraints on its hardware costs that may limit the amount of hardware that may be allocated to packet recognition. Alternatively, a device may have software limitations, e.g. storage space, availability of processing resources, operating system constraints, timing constraints, etc., that may limit implementing packet recognition in software. A tradeoff from step 100 may be that parsing of a packet header be performed in software or that parsing of a packet header be performed in hardware. A tradeoff from step 100 may be that decryption of a packet header be performed in hardware and that parsing of the packet header be performed in hardware.

At step 102, a functionality of the hardware portion of the packet recognizer is determined in response to the tradeoff from step 100. Step 102 may include determining a capacity of a capture buffer in the hardware portion. For example, if the tradeoff from step 100 is that decryption or parsing of a packet header be performed in software than a larger capture buffer is needed in comparison to a tradeoff in which decryption or parsing of the packet header is performed in hardware. Step 102 may include determining a set of functions in a capture circuit in the hardware portion. For example, if the tradeoff from step 100 is that decryption or parsing of a packet header be performed in hardware than decryption and parsing functions are needed in a capture circuit.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A packet recognizer comprising a hardware portion of the packet recognizer having a functionality that is selected in response to a tradeoff in a relative complexity of the hardware portion and a software portion of the packet recognizer.

2. The packet recognizer of claim 1, wherein the functionality of the hardware portion includes a capacity of a capture buffer in the hardware portion.

3. The packet recognizer of claim 1, wherein the functionality of the hardware portion includes a set of functions in a capture circuit in the hardware portion.

4. The packet recognizer of claim 3, wherein the functions in the capture circuit include a function for parsing a packet.

5. The packet recognizer of claim 3, wherein the functions in the capture circuit include a function for decrypting a packet.

6. A device, comprising:
capture buffer;
capture circuit that captures a portion of a packet while in transit between the device and a network communication link to the device, the capture circuit storing the portion in the capture buffer;
time synchronization code executing on the device that reads the portion from the capture buffer such that the portion enables the time synchronization code to parse the packet.

7. The device of claim 6, wherein the capture circuit causes a timestamp to be stored in the capture buffer in response to the packet.

8. The device of claim 6, wherein the portion of the inbound packet includes a header of the packet.

9. The device of claim 8, wherein the capture circuit captures the header in response to a field in the header that indicates a length of the header.

10. The device of claim 8, wherein the capture circuit captures the header by capturing a predetermined length of the header.

11. The device of claim 8, wherein the capture circuit filters the packet in response to a predetermined field in the header.

12. The device of claim 6, wherein the packet is an inbound timing packet received by device via the network communication link.

13. The device of claim 6, wherein the packet is an outbound timing packet generated by the time synchronization code.

14. The device of claim 6, wherein the capture circuit captures the portion while the packet is transferred between a physical interface to the network communication link and a media access controller in the device.

15. A method for providing a packet recognizer, comprising:
determining a tradeoff in a relative complexity of a hardware portion of the packet recognizer and a software portion of the packet recognizer;
determining a functionality of the hardware portion in response to the tradeoff.

16. The method of claim 15, wherein determining a functionality of the hardware portion comprises:
determining a capacity of a capture buffer in the hardware portion;
determining a set of functions in a capture circuit in the hardware portion.

17. The method of claim 16, wherein determining a set of functions in a capture circuit comprises determining whether the capture circuit is to parse a packet.

18. The method of claim 16, wherein determining a set of functions in a capture circuit comprises determining whether the capture circuit is to decrypt a packet.

19. The method of claim 16, wherein determining a capacity of a capture buffer comprises determining the capacity in response to a capacity of a header of a packet if the capture circuit is to parse the packet.

20. The method of claim 16, wherein determining a capacity of a capture buffer comprises determining the capacity in response to a capacity of a header of a packet if the capture circuit is to decrypt the packet.

21. The method of claim 15, wherein determining a tradeoff comprises determining the tradeoff in response to a set of costs associated with the hardware and software portions.
